(19) United States
(12) Patent Application Publication
(10) Pub. No.: US 2008/0039174 A1
(43) Pub. Date: Feb. 14, 2008

(54) Multiline video game play and apparatus with loss-line payout enhancing

(76) Inventor: Mark A. Litman, Edina, MN (US)

Correspondence Address: York Business Center;Suite 205, 3209 West 76th St., Edina, MN, 55435, US

(21) Appl. No.: 11/497,134

(22) Filed: Aug. 1, 2006

(51) Int. Cl. A63F 13/00

(52) U.S. Cl. 463/20

(57) ABSTRACT

A method and apparatus allows playing a wagering game. After placing a wager, the system provides multiple paylines and symbols appear on various paylines. Predetermined symbol events on paylines determine winning events and losing events. A wager is placed on more than one payline; at least one payline is designated a loss-determining payline; at least one payline is designated an influenced payline; symbols are provided to both the loss-determining payline and the influenced payline; and when the loss-determining payline has a losing event, a winning event on the influenced payline is increased.

### BACKGROUND OF THE INVENTION

1. Field of the Invention

The present invention relates to the field of mechanical, virtual/mechanical or video wagering games, and particularly physical or virtual multi-payline play games associated with slot-type wagering games.

2. Background of the Art

Competition in the gaming industry to attract a player and then retain the player's interest for protracted periods of time is an increasingly greater challenge. The environment in a casino is typically rich in stimulation, both auditory and visual. Consequently, it is an ongoing effort to attract a player to a given machine and then to subsequently encourage the player to stay at the machine based on the machine's entertainment value.

Many different variations in game machines and games played on the machines have been developed over the years to stimulate interest in games. The original games of 3-symbol and 4-symbol single payout lines on mechanical slot machines has progressed to multipayline, non-linear payline games with as many as 15 or more paylines active in a single game play, and scatter pays also being available for non-aligned symbols. Bonus play is available, with the same game, different games, same or different paytables, and with free spins and prizes rather than additional credits being awarded. Each of these advances has maintained the success of machine gaming.

The following references also disclose novel features taught for use in gaming machines.

U.S. Patent Application No. 20050130737 (Englman et al.) describes a gaming machine having an enhanced game play scheme is provided where, in response to receipt of a second wager to select an option, a player is provided with enhanced game play. Enhanced game play may include (1) providing more frequent bonus game play, (2) providing a larger bonus game value payout, (3) providing more frequent bonus game play and providing a larger bonus game value payout, (4) providing a larger or multiplied game value payout, (5) providing a guaranteed value payout for a non-winning outcome, (6) providing game features (7) providing a larger game value payout based on a partial game outcome, (8) providing an extra wild symbol capable of repositioning, and (9) providing a possibility of an additional reel movement to reposition an extra reel symbol or (10) providing a possibility of an extra pay line to include an extra reel symbol to increase a value payout. In yet a further embodiment, the additional coin-in per game may operate as insurance yielding a guaranteed value payout in the event of a non-winning outcome of game play.

U.S. Patent Application No. 20060025194 (McInerny et al.) describes a method and apparatus for selecting game elements in a gaming machine are described herein. In one embodiment, the method includes presenting a bonus event setting that includes a plurality of game elements and receiving a plurality of game element selections. In the method, each game element selection indicates that one of the game elements has been selected. Additionally, the method also includes presenting an animation sequence for each of the game element selections, wherein portions of the animation sequences are presented simultaneously. At block 204, a determination is made about whether an end-of-base-game condition has been satisfied. For example, the gaming control unit 112 determines whether an end-of-base-game condition has been satisfied. The end-of-base-game condition can be any game condition that indicates the base game is over. For example, in a video slot machine, an end-of-base-game condition can be satisfied after a non-winning reel-spin. A winning reel-spin can also satisfy an end-of-base-game condition. In alternative embodiments, where the base game is not video slots, the end-of-base-game condition can be satisfied in any suitable fashion. If an end-of-base-game condition has been satisfied, the flow ends. Otherwise, the flow continues at block 206.

U.S. Patent Application No. 20050079908 (Pacey) describes a gaming machine having an award-trading scheme and a method for conducting the award-trading scheme. The method includes receiving a wager to play the wagering base game and detecting a winning outcome to the wagering base game, and providing a first award option to a player of the wagering base game, where the first award option is displayed on a video display of the gaming machine. The method also includes precluding the player from receiving the winning credits and awarding the first award option to the player in response to the first award option being exercised by the player. The method further includes providing a second award option in response to the first award option not being exercised by the player. The first and second award options can include credits and free game play, to name a few. A gaming machine has an award-trading scheme whereby, for randomly selected winning outcomes during base game play, a player is provided with an award option. When the award option is selected by the player, the player is precluded from accepting the credits resulting from the winning outcome and instead receives the award associated with the option. In other words, the player trades the credits associated with the winning outcome for the award associated with the award option. Thus, the award option is provided to the player during base game play and therefore the player is permitted to enjoy the benefits typically associated with bonus game play without waiting for an occurrence of a bonus triggering event.

U.S. Patent Application 20040219969 (Casey et al.) describes a gaming machine with interactive pop-up windows providing enhanced game play schemes, including side-bet schemes, is described herein. Placing a side-bet utilizing interactive pop-up windows enables the player to make an additional wager to “purchase” one of any number of game enhancements, or to “side-bet” that the game outcome will include a particular symbol or symbol combination, depending on the side-bet scheme enabled for a particular gaming machine. In an embodiment, the player has an option to select one or more side-bet(s) via a pop-up window(s) prior to game play initiation. In another embodiment, the player has an option to select one or more side-bet(s) via a pop-up window(s) after a partial game outcome is displayed. The method of side bet play can be effected after a response to detecting the second wager by having a predetermined number of credits is awarded to the player if the outcome of the wagering game is a non-winning outcome, the predetermined number of credits based on the second wager amount.

U.S. Pat. No. 6,893,344 (Brown et al.) describes a secondary game in communication with a primary gaming machine, is preferably based on a sport, namely American football. The present invention, unlike previous secondary games is triggered in response to both predefined winning and non-winning primary game outcomes. The secondary game awards a bonus pay out in response to a player achieving a predefined bonus event. The bonus event may be scoring a touchdown, getting a first down or any desired football related event. Once the secondary game is triggered by one or more predefined winning primary game outcomes, a random number generator selects a secondary game football related outcome (e.g. five yard gain, two yard loss, etc). In a preferred embodiment, the football outcome is revealed on a display depicting video football footage. Moreover, if the primary game outcome is a predefined non-winning outcome, the secondary game is instructed to advance the football a pre-established modest distance.

U.S. Patent Application No. 20010054794 (Cole et al.) describes a game having a bonus feature and a gaming apparatus for presenting the game are disclosed. One embodiment of the method comprises the steps of a player placing a wager, spinning a plurality of first reels having indicia thereon, determining if indicia displayed by the plurality of first reels associated with a first pay line comprises a predetermined winning combination, and if so, paying a first award and then associating that first award with at least one bonus game, permitting at one or more times the player to participate in the bonus event, and determining if the outcome of the bonus event is a winning outcome and if so, paying a bonus award. In one embodiment, the gaming device includes three first mechanical or video-generated reels for playing the first game, one second mechanical or video-generated reel for playing the bonus event, and associated mechanisms for accepting wagers, paying winnings, and associating win amounts from the first game with the at least one bonus reel. An example of the play of a game in accordance with the above-method will now be described with reference to FIGS. 3(a)-(d). First, a player inserts money for playing the game. In one embodiment, the player is then permitted to either spin the bonus reel or the main game reels. If the bonus reel is empty, it is presumed that the player will likely elect to spin the main game reels 22. Presume that the player receives the combination of indicia comprising the symbols of a star, moon, and sun (see FIG. 3(a)) and this is a non-winning combination. The player is declared a loser and it is next determined if the player is entitled to play the bonus game. In one embodiment, the player is automatically entitled to play the bonus game. In another embodiment, since the player has not yet won the main game, unless one or more indicia 42 are associated with the bonus reel 40 from a prior game to played by another player, then the player is not permitted to play the bonus game. Presuming that one or more indicia/values are associated with the bonus reel 40 (for example, if the previous player of the apparatus spun the bonus reel on their last play, then all of the indicia would have been removed from the bonus reel 40 in step S13 and the bonus reel is empty except for the “win all” indicia 44, as illustrated in FIG. 3(a)), then the player must place another bet to continue.

U.S. Pat. No. 6,875,106 (Weiss) describes a method and apparatus for a gaming device in which a player is awarded outright for a winning combination and is eligible for a reward if the displayed outcome can be manipulated by the gaming device to produce a winning combination. A special bar symbol can be coupled with a certain bar subset of the universe of symbols to initiate a further award, perhaps coupled with a multiplier. Preferably, a bonus is provided which includes overlapping exhibitors such as wheels having a sector defining the overlap indicating a bonus element which is placed on an array. A series of elements on the array, when forming a pattern which is recognized by the game results in added credits. The game provides a method and apparatus to transform certain non-winning outcomes into winning outcomes without further effort on the part of the player. This effectively provides the player with a greater opportunity of winning the game. The game preferably transforms the first outcome only if the second outcome provides a payout. Accordingly, it is a primary object is to provide a new and novel method and apparatus for rewarding a player whether the player wins or nearly wins an initial game according to both a paytable and a rule set.

U.S. Patent Application No. 20060148548 (Hornik et al.) describes a wagering game system including a gaming system for playing a wagering game with an input device adapted to receive an input from a player of the wagering game, a processor configured to determine a wagering game outcome, and a gambling feature incorporating a game in which a player is statistically more likely to win than to lose, wherein the gambling feature is enabled by a wagering game outcome that includes a winning combination. Generally, the wagering game incorporates a gambling feature with a high-payout percentage game in which a player is statistically more likely to win than to lose. The gambling feature would be enabled, for later activation upon some predetermined event in the basic game or some other event, or activated in response to an outcome in the wagering game comprising a start-gambling feature outcome. The start-gambling feature outcome could include, in one preferred aspect, any winning combination. In other aspects, the start-gambling feature outcome could comprise one or more selected winning combinations or, alternatively, one or more selected non-winning combinations.

U.S. Patent Application No. 20060116194 (Pacey et al.) is directed to a gaming machine and a method of playing a wagering game having a basic set of rules for playing a wagering game. Under the basic set of rules, a player can accumulate and save assets that are associated with the wagering game. In addition to the basic set of rules, the wagering game includes modifiers to the basic set of rules that modify the assets, enhance the assets or provide new assets. These modifiers may, for example, multiply an award associated with an asset or group of assets, provide additional rolls of the dice, provide a bonus award, provide additional player selections, allow the player to continue game play after a game-terminating event has occurred, allow the player to use assets at a later gaming session, or allow a player to access new assets at a different gaming machine. The assets and modifiers can be shared by players at different gaming machines to influence the outcome of the wagering games and can be saved for use in subsequent gaming sessions. Some of the assets of the wagering game include assets that modify the basic set of rules of the wagering game. These rule-set-modifier assets may enhance the assets already collected by a player or provide new assets to further increase the excitement level of the wagering game. For example, the rule-set-modifier assets may, inter alia, multiply an award associated with an asset or group of assets, provide additional rolls of the dice, provide a bonus award, provide additional player selections, allow the player to continue game play after a game-terminating event has occurred, allow the player to use assets at a later gaming session, or allow a player to access new assets at a different gaming machine.

U.S. Patent Application No. 20050170877 (Okuniewicz) describes a printing and dispensing system for an electronic gaming device. The system includes a gaming device with a processor that generates an outcome for the gambling device and a bonus system that generates payout that is supplemental to the payout of the gaming device. The supplemental payout is generated is response to gaming events in the gaming device. Embodiments include the dispensing or printing of a bonus item from a secondary output device not directly associated with the standard payment device on the gaming device which is most commonly a coin or scrip dispenser. The bonus may be dispensed in connection with a predetermined event or series of events occurring on the gaming device, such as coin in or a particular combination being “hit” on the electronic gaming device. Such a bonusing system which would both increase game play and decrease the dissatisfaction of the consumer, as a reel combination that is not ordinarily a payout combination may result in the obtaining of bonus prizes.

U.S. Patent Application 20030032470 (Weiss et al.) describes a method and apparatus for a gaming device in which a player is awarded outright for a winning combination and is eligible for a reward if the displayed outcome can be manipulated by the gaming device to produce a winning combination. A special bar symbol can be coupled with a certain bar subset of the universe of symbols to initiate a further award, perhaps coupled with a multiplier. Preferably, a bonus is provided which includes overlapping exhibitors such as wheels having a sector defining the overlap indicating a bonus element which is placed on an array. A series of elements on the array, when forming a pattern which is recognized by the game results in added credits.

U.S. Patent Application No. 20030008698 (Stone) describes a method and apparatus for a gaming device in which a player is awarded outright for a winning combination and is eligible for a reward if the displayed outcome can be manipulated by the gaming device to produce a winning combination.

U.S. Pat. No. 6,875,106 (Weiss) describes a method and apparatus for a gaming device in which a player is awarded outright for a winning combination and is eligible for a reward if the displayed outcome can be manipulated by the gaming device to produce a winning combination. A special bar symbol can be coupled with a certain bar subset of the universe of symbols to initiate a further award, perhaps coupled with a multiplier. Preferably, a bonus is provided which includes overlapping exhibitors such as wheels having a sector defining the overlap indicating a bonus element which is placed on an array. A series of elements on the array, when forming a pattern which is recognized by the game results in added credits.

U.S. Pat. No. 6,840,860 (Okuniewicz) provides a printing and dispensing bonusing system for electronic gaming devices, particularly a casino gaming device, which includes at least one detection device which is adapted for connection to an electronic apparatus, the detection device operative to detect selected event occurrences on an electronic apparatus and output event occurrence notification signals upon detection of an event. An event detection sampling device is connected in information transmission connection with the detection device, the event detection sampling device operative to detect and receive event occurrence notification signals from the detection devices, analyze the received event occurrence notification signals and output event occurrence information signals including information specifying selected event occurrences. Connected in information transmission connection with the event detection sampling device is an event occurrence information signal computing device which is operative to receive and analyze the event occurrence information signals output by the event detection sampling device and upon detection of selected event occurrence information signals, output command signals for initiating operation of at least one bonus printing and dispensing device connected thereto, independent of a standard output device of the electronic gaming device and operative to accept command signals from the computing device and to print and dispense bonus information and awards resulting from selected combinations being produced by the electronic gaming device whereby an operator/player of the electronic gaming device is awarded selected bonus items and awards.

U.S. Patent Application No. 20050208988 (Parker) describes a gaming apparatus and a method of playing a game including steps of: presenting a combination of symbols generated in an at least apparently random manner; determining whether the combination results in a win state or a lose state; modifying a value in at least one win store upon a win state, and applying a modified pay out schedule for a win state resulting from at least one subsequent symbol generation step if at least one of the win stores contains a target value. The display produced by the second embodiment of the game includes a set 201 of ten arrows leading to a Triple Pay Bonus symbol 202. If a player loses a hand upon which he had placed the maximum bet then one of the arrows 201 is lit up. The next game upon which he has placed the maximum bet and lost results in the next arrow of the set 201 being lit, and so on. However, if the player wins a maximum bet game then all of the arrows 201 are switched off. Therefore, if the player plays ten consecutive non-winning games upon which he has bet the maximum amount, all ten arrows 201 and the Triple Pay Bonus symbol 202 are lit and the value of any winning hands achieved during the five games that immediately follow are tripled. Numbers in the triple pay panel 203 are used to indicate the number of triple pay games the player has left to play. After the five games have been played, all the arrows 201A and the panels 202 and 203 are switched off and play continues.

U.S. Patent Application No. 20030220133 (Walker et al.) describes a method for outputting an outcome for a game of a gaming device is presented, wherein the method comprises first outputting an apparent outcome for the game and then outputting an actual outcome for the game. In one or more embodiments, a benefit corresponding to the apparent outcome may not be provided to the player playing the gaming device. For example, a hopper may be prevented from dispensing a payout associated with the apparent outcome. In accordance with one or more embodiments, a character (e.g., an animated character) may be displayed as changing the apparent outcome into the actual outcome.

As can be seen from a review of these and other cases, one element of the game that is attempted is to find a way to make losing event appear to be less painful for frustrating for players by offering some potential consolation for a loss or multiple losses. It is clear that this venue can be used to provide other alternatives that satisfy other gaming efforts, such as maximizing the number of credits wagered at each play of the game.

### SUMMARY OF THE INVENTION

A gaming apparatus provides symbols in multiple pay lines in a player viewable area by physical reels or virtual video reels. When multiple pay lines are played during a single game on the apparatus, a losing event on one payline (referred to as the “losing line”) can be used to alter a winning event on a different payline (referred to herein as the “influenced line”). The losing event may be any losing event or a particular class of losing event that is required to increase a winning event on a different payline. The mapping of the reel or virtual reel on which the losing event may occur may be particularly mapped to control the probability of the particular losing event occurring. The player may be provided with an automatic losing line or may select a particular payline as the losing line and may be automatically assigned or select a particular payline as the influenced line.

### BRIEF DESCRIPTION OF THE FIGURES

FIG. 1 shows a gaming apparatus video screen with multiple paylines, with one payline identified as a losing line and another identified as an influenced line.

FIG. 2 shows the screen of FIG. 1 with a selected losing payline in the bottom row and a winning event in the influenced diagonal payline.

FIG. 3 shows a 3×5 screen with loss-determining payline and influenced payline highlighted.

### DETAILED DESCRIPTION OF THE INVENTION

A gaming apparatus provides symbols in multiple pay lines in a player viewable area by physical reels or virtual video reels. When multiple pay lines are played during a single game on the apparatus, a losing event on one payline (referred to as the “losing line”) can be used to alter a winning event on a different payline (referred to herein as the “influenced line”). The losing event may be any losing event or a particular class of losing event that is required to increase a winning event on a different payline. The mapping of the reel or virtual reel on which the losing event may occur may be particularly mapped to control the probability of the particular losing event occurring. The player may be provided with an automatic losing line or may select a particular payline as the losing line and may be automatically assigned or select a particular payline as the influenced line.

Gaming apparatus (a collective term for physical reel games, originally known as slot machines and video games with symbols and defined paylines) are provided with multiple paylines. A payline is a grouping of frames or spaces where symbols are displayed that define a set. Each set is evaluated according to game rules to determine whether or not a winning event or a losing event occurs because of the particular symbols displayed, the order of symbols displayed and the combination and order of symbols displayed. A paytable is usually defined that identifies what winning events are and what the respective payouts are for each winning event. All events and distributions of symbols that are not shown in the paytable as a winning event are losing events in which all wagers placed on that payline are lost in the game event. A few simple examples of available symbols, paytables, winning events and losing events are provided below for a 5×5 display of symbols:

### Available Symbols

### 7 A ♦ ♡ and blank spaces with no symbols

### Winning Events in Paytable

| A ♦ ♡ [symbol] | In order, 500:1 |
|---|---|
| A ♦ ♡ [symbol] | In any order, 250:1 |
| A A A A A | 100:1 |
| 7 7 7 7 7 | 50:1 |
| A 7 7 7 7 | In any order, 40:1 |
| A A 7 7 7 | In any order, 20:1 |
| A A A 7 7 | In any order, 10:1 |
| A A A A 7 | In any order, 5:1 |
| 7 7 7 | In consecutive frames 2:1 |
| 7 7 7 | In any frames in payline, 1:1 |

### Special Effect Triggering Losing Events

### All frames are blanks 2:1 on influenced line win

| | |
|---|---|
| 7 ♦ ♡ [symbol] | 3:1 on influenced line win, with 7 in first frame, |
| | other symbols in any order. |
| [symbol] ♦ ♡ [symbol] | 4:1 on influenced line win, with smiley face in |
| | first frame, other symbols in any order. |
| [symbol] ♦ ♡ [symbol] | 5:1 on influenced line win, with music notes in |
| | first frame, other symbols in any order. |
| [symbol] ♦ ♡ [symbol] | 10:1 on influenced line win, with sun in first frame, |
| | other symbols in any order. |

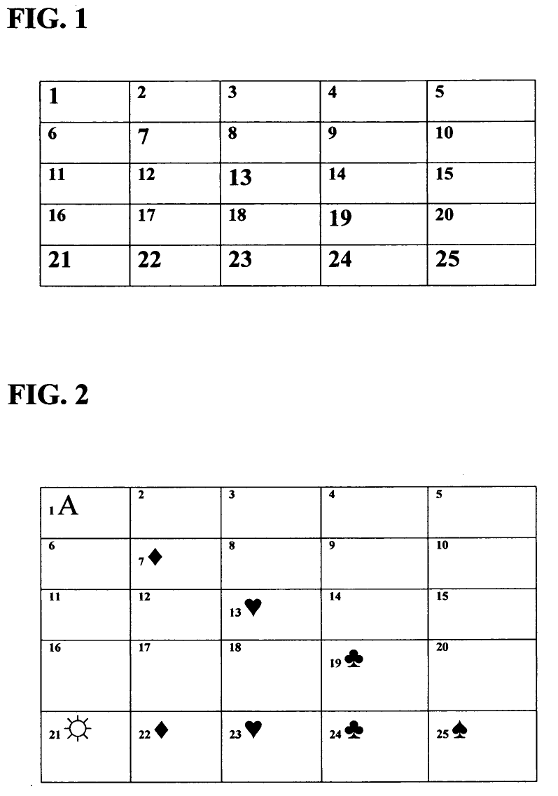

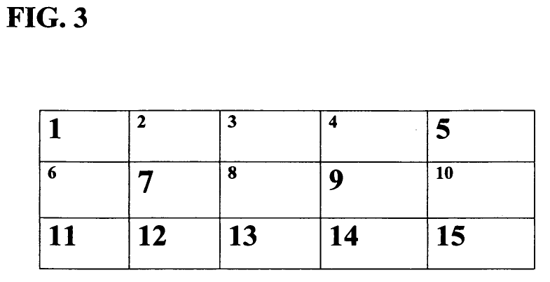

As is known in the art, there may be a great number of paylines available for play in a single game of play. Looking at FIG. 1, the numbers frames provide 3 horizontal rows each of which is a potential payline, 5 vertical columns (on a video screen where adjacent frames are not fixed as in a physical reel) each of which is a potential payline, two diagonal lines of frames, and many combinations of non-linear frames in a line across the screen (e.g., frames 1, 7, 3, 9, 5; frames 6, 2, 8, 4, 10; and the like) and in FIG. 3 with a 3×5 set of frames (11, 12, 13, 14 and 15 are the losing payline and frames 1, 7, 13, 9 and 5 form the influenced payline). In the play of this game, any type or shape of linear or non-linear payline may be used as either the losing line or the influenced line.

When a player begins play on the gaming apparatus, a wager amount is selected and a number of paylines to be played is selected. A typical player interface panel with touchscreens or buttons on a panel will offer various selections which may include the following non-limiting list of selections.

1 Credit per Payline

2 Credits per payline

3 Credits per payline

4 Credits per payline

5 Credits per payline . . . etc.

1 Payline,

2 Paylines,

3 Paylines,

4 Paylines . . .

Paylines . . . etc.

The player makes the desired selection of the number of credits per payline (which may or may not be selectable according to individual paylines) and the “spin” starting the game automatically begins (as with a maximum wager on all parameters or after a time delay once some wager has been made). The systems are randomly distributed around the frames of the video screen according to the mapping of the reels and/or the mapping of the frames. A processor then evaluates the distribution, type, location and/or order of symbols and determines if a winning event has occurred in any wagered payline. In the present game, the processor will also evaluate whether sufficient wager has been placed and enough paylines have been wagered so that if a losing event has occurred on the losing line, the influenced line is considered, and if a winning event has also occurred on the influenced line, that winning event will then have the winning payout altered by adding a fixed amount to the winning result, an additional factor of the wage on the influenced line added to the win, or an additional multiplier added or used on the winning result. These types of effects are sufficiently distinct as to warrant additional descriptions.

The benefit of a loss on the losing payline may be transferred to the influenced payline in at least the following list of ways:

When there is a defined loss on the losing line, an absolute credit amount (e.g., 10 credits) may be added to any winning event or a particular level of winning event (e.g., at least three-of-a-kind in a poker format) on the influenced line.

When there is a defined loss on the losing line, a multiple of the wager placed on the losing line or the influenced line will be added to the resolution of the winning event on the influenced line.

When there is a defined loss on the losing line, a multiplier may be used on the wager placed on the influenced line or on the multiplying odds for the winning event, and the wager on the influenced line thereby actually multiplied.

When there is a defined loss on the losing line, an additional wager amount may be automatically added to the influenced line (thus enabling less than whole integer multipliers of the wager). For example, if the original wager on the losing line and the influenced line were 5 credits, and the special losing event occurred on the losing line, an additional effective wager amount of 1, 2, 3, 4 or 5 credits (or more) could be added to the effective wager placed on the influenced line, thus making the wager that is resolved on the winning influenced line event 6, 7, 8, 9 or 10 (or more) credits.

Combinations of these effects can also be used, or (non-cashable) free spins at a defined wager level can be offered based on an equivalence between credits that would have been won and the number of free spins. For example, if there is a defined specific losing event on the lose payline and a win on the influenced payline, 5, 10, 15, or 25 free spins may be provided to the player.

The player may select the losing payline as a specific payline or the processor may automatically select a payline as the losing line. The screen may highlight the losing line before, during or after assigning symbols to the payline. The player may select the influenced payline as a specific payline or the processor may automatically select a payline as the influenced line. The screen may highlight the influenced line before, during or after assigning symbols to the payline. The highlighting may be done whether or not the losing/influenced line event is activated by sufficient wagering on the game to inform a player of benefits that might have occurred during play. The play of this format may be and is preferably made dependent upon the amount or type of wagering done on the game apparatus. For example, in a simplest form, if the player makes a maximum wager on all paylines, then a specific payline becomes the losing payline and another specific payline becomes the influenced payline. For example, looking at FIG. 3, the lowest row is automatically the lose payline and the diagonal payline is automatically the influenced payline when the approximately 15 paylines are all selected with a 5 credit/payline wager made.

It is possible to allow that any number of wagers on a sufficient number of paylines engages the loss payline benefit, but it is desirable from the casino's standpoint to promote larger numbers or wagers and larger numbers of paylines before the benefit is provided. This also can be done in a wide variety of ways and formats. For example, the simplest format would be that a specific payline is a loss payline and another specific payline is the influenced payline only when the maximum number of paylines and the maximum number of credits is wagered on a round of play. Another format could be that when five paylines (or any other specific minimum number of paylines) is wagered on one specific payline becomes the loss payline (e.g., the first payline) and another automatically becomes the influenced payline. Another format may require both a minimum specific number of paylines and a specific number of credits be wagered for a specific payline to become a loss payline and another specific payline to become the influenced payline.

Another alternative format of play is to have a single loss payline become associated with more than one influenced payline as greater numbers of credits are played, such as having a single influenced payline when four credits per payline are wagered and having two influenced paylines when five credits per payline are wagered. Alternatively, there may be more than one loss payline associated with a specific influenced line, or multiple pairs of loss paylines and influenced paylines depending upon the number of paylines played and the number of credits played per payline. For example, when a maximum number (e.g., 15) paylines are wagered with maximum credits per payline, a) payline 1 may be the loss payline for influenced payline 15; b) payline 1 may be the loss payline for influenced paylines 5 and 10; c) payline 1 and payline 5 may be the loss paylines for influenced payline 15; or d) payline 1 may be the loss payline for influenced payline 5 and payline 10 may be the loss payline for an influenced payline 15.

There are also a range of losing events that may be used to trigger the losing payline/influenced payline beneficial event. As the occurrence of losing events is higher on a given payline then the occurrence of a winning event, one format for controlling the occurrence of the losing payline/influenced payline beneficial event is to require specific types of losing events on the losing payline to trigger the event. For example, a payline may often have a 70% likelihood or higher for losing events and it would be too generous to allow the losing payline/influenced payline beneficial event to occur that frequently. Therefore, the event may be controlled by requiring not only a minimum number of paylines and credits to be wagered, but also to require specific types of losses. This has been shown above in the description of specific losing triggering events described above. For example, a triggering event could be any losing event without a 7 A or blank space; a losing event with all blank spaces; a losing event with specific types or orders of symbols; or even specific consecutive numbers of losing events on a specific losing payline.

The play of the game technology herein, which can be titled such various names as “Rain-or-Shine,” “Win-for-Losing,” “Silver Linings” or other various titles, can be played as a base game or as a feature added with a side bet wager. For example, the game may be played with the qualifying maximum wager triggering play of the game technology as described above, a separate wager may be placed for play of that game, a side bet wager may be placed for play of the game, an incremental wager or side bet wager may be placed for play of the game, or other elective wagers placed. For example, with 2 paylines and 5 credits per wager, the player may place a 1 credit wager to have the option of playing the losing payline/enhanced payline wager, and with 15 paylines and 5 credits per wager, the player may need to wager 1, 2, 3, 4 or 5 credits to engage the losing payline/enhanced payline event. Additionally, any free spins won in the play of the underlying game, other side bet wagers, bonus rounds or in any other manner may automatically be used with the losing payline/enhanced payline event or may be used as the equivalent of credits to enter the event.

The actual play of the event may be artistically or dramatically enhanced by the format or protocol of display of the triggering images. For example, if the presence of a single symbol (e.g., [symbol] triggers the losing payline achievement), that symbol may be animated or highlighted and morph into another symbol (e.g., [symbol] ) to give more visual anticipation to the event. After the symbol is promoted by this activity, the entire payline may then be highlighted to enhance the activity and presence of the game event. Prior to the influenced line having its symbols evaluated, that line may also be highlighted, possibly with a different highlighting feature to emphasize the difference. For example, the losing payline may be highlighted in one color (e.g., green) and the influenced payline may be highlighted in a different color or by magnifying the payline. It is also possible, to enhance the expectancy or hopeful tension in the play of the game that when a losing payline triggering event occurs, the play of the game may allow a further spin of the influenced payline(s) only for no additional credits or with additional credits (and thereby effectively offering a higher payout rate on that spin). For example, if there is a triggering event in loss-determining payline 11, 12, 13, 14, 15 in FIG. 3, and there is no winning event in influenced payline 1, 7, 13, 9, 5, then there could be an automatic free spin available to the player or another spin, at the same or fewer credits per payline, solely for the influenced line(s). If the initial credits wagered on the influenced payline had been 5 credits for example, the equivalent of a cherry in the first frame would pay 10 credits normally. If the triggering loss-determination event provides a multiplier of 2×, a 5 credit wager and a cherry result would now pay 20 credits, thereby increasing the paytable.

It is also possible that when the loss-determining or triggering event in the loss-determining payline establishes an additive benefit to the influenced payline (e.g., an additional 10 credits to the winning amount of the influenced payline), the influenced payline may or may not be required to actually win to have the amount added. It is preferred that there must be a winning (or push, returning 1:1 for a wager) event in the influenced payline to earn the additive amount.

Various different themes may be used to enhance the play of the game and other alternative methods of entering the play of the event can be envisioned within the scope of the present disclosure. The considered best modes of practicing the invention would be as follows:

A player makes at least a play wager on a multiline video slot game. The wagering game is played on a gaming apparatus comprising a player-input interface, a processor and a monitor, and multiple paylines (at least 2, preferably at least 5, more preferably at least 10 or at least 15 paylines) are provided and symbols appear on various frames within the paylines on the monitor. Predetermined symbol events on paylines determine winning events and losing events in an underlying video game. To play the game event of the advanced technology described herein, a wager is placed by a player on more than one payline to automatically enter the loss/influence game play or a side bet wager (e.g., 1 credit for each loss payline automatically selected by the processor or individually selected by the player). At least one is selected or designated as a loss-determining payline, or defined sets of paylines are defined or selected as relative loss-determining payline(s) and influenced payline(s). For example, with one side bet wager placed, paylines 1 and 5 are matched (one-way or two-way) as loss-determining payline and influenced payline. With two side bet wager credits placed, paylines 1 and 5, and paylines 2 and 6 are associated as loss-determining and influenced paylines; etc. In any event, at least one payline is designated a loss determining payline and at least one payline is determined as an influenced payline. The assignment of associated lines may also be randomly selected by the processor. In the “spin” of the frames, symbols are provided to both the loss-determining payline and the influenced payline. When the loss-determining payline has a losing event, any winning event on the influenced payline is increased.

Although the general disclosure emphasizes actual losing events on a payline as a basis for increasing the payout offered on another payline, and especially a winning payline, there is believed to be additional novelty in the practice of the invention as follows. The appearance of a particular symbol or particular set of symbols on a first payline (previously referred to as the loss-determining payline) establishes a change in the payout on one payline, more than one payline, or all paylines, preferably where those paylines are winning paylines or are required to be winning paylines. For example, the appearance of the smiley face (e.g., [symbol] ) on the loss-determining line may be used to increase the payout on another line, more than one line or all paylines even if other symbols on the loss-determining payline establish a winning event. The system may require that the loss-determining payline actually lose or push, and this can be done by evaluating whether the win on the influenced line is increased by an amount more than the win on the loss-determining line. If multiple specific symbols, especially specific multiple losing symbols appears on the loss-determining payline, more than one influenced payline may be established, up to and including all other paylines. For example, if all five frames on the loss-determining payline are the smiley faces, then all other paylines are subject to an increased award as if all paylines were influenced paylines. For example, all paylines could be doubled if the loss-determining payline, or any payline has five smiley faces or other special symbol, whether or not those symbols cause a win or allow for a loss of all wagers on that payline. An important and generic element of the practice of the technology is that an event or symbol, or combination of symbols on a particular or general payline causes enhancement of a winning outcome on another payline, and this is done without the use of wild symbols, or exchanges of symbols and the like. Those additional features may be added to the practice of this technology, but are not an essential element or necessarily a novel element or step in the scope of the present technology.

Although specific examples and details have been provided in the description of the present technology, these specifics and details are not intended to limit the scope of the claimed technology. For example, the symbols used are not limiting, the nature of the display screen is not limiting, the operating system from the processor is not limiting, the paytables, credits wagered, number of paylines, and the like are not limiting. Similarly, the game technology described herein may be played on a single and separate apparatus, a bank of independent machines, on the internet, on a remote from a hotel room, on a personal wagering device that engages another machine by wireless connection and the like.

What is claimed:

1. A method of playing a wagering game on a system wherein multiple paylines are provided and symbols appear on various paylines and predetermined symbol events on paylines determine winning events and losing events, wherein:
a wager is placed on more than one payline;
at least one payline is designated a loss-determining payline;
at least one payline is designated an influenced payline;
providing symbols to both the loss-determining payline and the influenced payline; and
when the loss-determining payline has a losing event, a winning event on the influenced payline is increased.

2. A method of playing a wagering game on a gaming apparatus comprising a player-input interface, a processor and a monitor wherein multiple paylines are provided and symbols appear on various paylines on the monitor and predetermined symbol events on paylines determine winning events and losing events, wherein:
a wager is placed by a player on more than one payline;
at least one payline is designated a loss-determining payline;
at least one payline is designated an influenced payline;
symbols are provided to both the loss-determining payline and the influenced payline; and
when the loss-determining payline has a losing event, a winning event on the influenced payline is increased.

3. The method of claim 1 wherein a minimum of five paylines are provided by the system during play of a single game and the player must wager on at least five paylines to have a winning event on the influenced payline increased because of a loss on the loss-determining payline.

4. The method of claim 2 wherein a minimum of five paylines are provided by the system during play of a single game and the player must wager on at least five paylines to have a winning event on the influenced payline increased because of a loss on the loss-determining payline.

5. The method of claim 3 wherein a minimum number of credits must be wagered on the at least five paylines to have a winning event on the influenced payline increased because of a loss on the loss-determining payline.

6. The method of claim 4 wherein a minimum number of credits must be wagered on the at least five paylines to have a winning event on the influenced payline increased because of a loss on the loss-determining payline.

7. The method of claim 3 wherein only a single loss-determining payline is provided for only a single influenced payline.

8. The method of claim 4 wherein only a single loss-determining payline is provided for only a single influenced payline.

9. The method of claim 6 wherein only a single loss-determining payline is provided for only a single influenced payline.

10. The method of claim 1 wherein the loss-determining payline and the influenced payline are designated automatically by the system.

11. The method of claim 4 wherein the loss-determining payline and the influenced payline are designated automatically by the system.

12. The method of claim 1 wherein at least one of the loss-determining payline and the influenced payline are designated by a player.

13. The method of claim 1 wherein only specific losing events on the loss-determining payline must appear to have a winning event on the influenced payline increased because of a losing event on the loss-determining payline.

14. The method of claim 2 wherein only specific losing events on the loss-determining payline must appear to have a winning event on the influenced payline increased because of a losing event on the loss-determining payline.

15. The method of claim 4 wherein only specific losing events on the loss-determining payline must appear to have a winning event on the influenced payline increased because of a losing event on the loss-determining payline.

16. The method of claim 8 wherein only specific losing events on the loss-determining payline must appear to have a winning event on the influenced payline increased because of a losing event on the loss-determining payline.

17. An electronic apparatus having a processor, video screen, value accepting functionality and player input interface that enables wagering according to the method of claim 1.

18. An electronic apparatus having a processor, video screen, value accepting functionality and player input interface that enables wagering according to the method of claim 1.

19. The method of claim 1 wherein if a losing event has occurred on the loss-determin payline, the influenced payline is considered, and if a winning event has also occurred on the influenced payline, that winning event will then have the winning payout amount altered by adding a fixed amount to the winning result, providing an additional factor on the wager on the influenced line, an additional multiplier added or used on the winning result, or an additional credit amount added to the wager on the influenced payline.

20. The method of claim 1 wherein if a losing event has occurred on the loss-determin payline, the influenced payline is considered, and if a winning event has also occurred on the influenced payline, that winning event will then have the winning payout amount altered by adding a fixed amount to the winning result, providing an additional factor on the wager on the influenced line, an additional multiplier added or used on the winning result, or an additional credit amount added to the wager on the influenced payline.
